(19) United States
(12) Patent Application Publication
(10) Pub. No.: US 2014/0362255 A1
(43) Pub. Date: Dec. 11, 2014

(54) System and Method for providing photograph location information in a mobile device

(71) Applicant: Shaobo Kuang, Iansdale, PA (US)

(72) Inventor: Shaobo Kuang, Iansdale, PA (US)

(21) Appl. No.: 13/913,469

(22) Filed: Jun. 9, 2013

(51) Int. Cl. H04N 5/232

(52) U.S. Cl. CPC H04N 5/23229; H04N 5/23293
USPC 348/231.5

(57) ABSTRACT

A mobile device includes a viewfinder, focusing unit for allowing users to select or focus an object in said captured image, a GPS, a compass, a distance unit for measuring the distance between the mobile device and the object, a calculating unit for calculating the current position of the object based on the position of the mobile device, the direction of the object and the distance between the mobile device and the target, a search unit for searching target, a display unit for display a hint or indication of the target.

The present invention is based on the provisional Patent Application, Ser. No. 61/690,349, filed on Jun. 25, 2012, titled “System and Method for providing photograph location information in a mobile device”.

### FIELD OF THE INVENTION

This invention relates to the technology of mobile devices, and more particularly to provide or obtain photograph location information in mobile devices.

### BACKGROUND OF THE INVENTION

A mobile device or a wireless communication device, also referred to as a mobile phone, a wireless handset, etc., may include a built-in camera module or unit. These “camera phones” may include a variety of features such as built in flash, auto focus (AF), wireless Internet connection, and a built-in global position system (GPS), zoom-in, zoom-out, etc. Some photographs taken by camera phones include a time and a date stamp associated with each image base on settings by the manufacturer or the user. Now, mobile devices, like IPhone or IPad, or even GOOGLE glasses, are used very frequently during the whole day of many functions, from phoning to sending or receiving messages to or from their friends, from reading news to playing music. Many mobile devices are used to capture, store, and share images, such as still photographs, and even video. Many mobile devices, now, function much like digital cameras enabling their users to take or view pictures (still or video) and to view digital images of the pictures taken.

Once a targeted photograph or picture is taken by a mobile device user through a mobile phone with a built-in camera and a built-in GPS, the photograph can be stored in the phone for later viewing on the phone. The user can also download the photographic images to a PC, a TV, or even to a storage space on a cloud server. During the user's taking a photograph or a picture, the built-in GPS receives global position information for the mobile phone. However, the obtained global position information is for the mobile device, but not really for the targeted photograph or picture, which a user is focusing on and he is more interested in.

Therefore, it would be advantageous to have some additional systems and methods to increment user friendliness and automation of many frequent operations on such mobile devices. Also to have additional and innovative functionalities on such mobile devices is desirable.

### SUMMARY OF THE INVENTION

It is therefore the objects of the present invention are intended to overcome the drawbacks of the conventional art.

Accordingly, an object of the present invention is to provide methods and systems for obtaining global position for targets in pictures taken by users through mobile devices.

Another object of the present invention is to provide methods and systems for displaying information about the targets in pictures taken by users through mobile devices.

Another object of the present invention is to provide methods and systems for displaying the information about the targets in the pictures taken by users through mobile devices in a text mode.

Another object of the present invention is to provide methods and systems for displaying the information about the targets in the pictures taken by users through mobile devices in a video mode.

Another object of the present invention is to provide methods and systems for displaying the information about the targets in the pictures taken by users through mobile devices in an audio mode.

Another object of the present invention is to provide methods and systems for determining the match between a focused target and a known target in the camera screen in mobile devices.

Another object of the present invention is to provide methods and systems for real time matching the focused object and the users' interested object.

Another object of the present invention is to provide methods and system for ranking objects by the number of the cameras which are focusing on them.

A method for a mobile device, which includes a built-in a digital camera, comprising the steps of:
selecting or focusing one or more objects in an image associated with a viewfinder or a display unit of the digital camera;
obtaining the current positions of said objects;
sending the obtained current positions of the objects to a search engine or a built-in local map system for retrieving or querying the information about the objects,
receiving retrieving or querying results from the search engine or the built-in local map system
producing hints or indications of the objects based on the retrieved results.

A method for a mobile device, which includes a built-in a digital camera, a GPS or LBS device, a digital compass, and a distance measuring unit, comprising the steps of:
selecting or focusing an object in an image associated with a viewfinder or a display unit of the digital camera;
obtaining the current position of the mobile device from the GPS device;
obtaining the direction of the object from a digital compass;
measuring the distance between the mobile device and the object from a distance measurement device;
calculating the current position of the object based on the position of the mobile device, the direction of the object and the distance between the mobile device and the object;
sending the current position of the object to a search engine or a built-in local map system for retrieving the information about the object;
producing a hint or an indication of the object based on the retrieved information;
displaying the hint or the indication of the object in the viewfinder or the display unit.

A mobile device having a camera system comprising:
a viewfinder or display unit that captures an image from a lens in said camera;
a selecting or focusing device for allowing users to select or focus an object in said captured image;
a position device for obtaining the global position or location of the mobile device;
a digital compass device for obtaining the direction of said selected or focused object;
means for measuring the distance between the mobile device and the object;
means for calculating the current position of the object based on the position of the mobile device, the direction of the object and the distance between the mobile device and the object;
means for submitting the current position of the object to a search engine or a local map database for retrieving or querying the information about the object;
means for receiving results of the retrieve or the query from the search engine or the local map database;
means for producing a hint or a indication for the object based on the retrieving results.

### BRIEF DESCRIPTIONS OF THE DRAWINGS

Referring now to the drawings in which like reference numbers represent corresponding parts throughout:

FIG. 1 is a block diagram showing a mobile device in which preferred embodiments in accordance with the present invention are implemented.

FIGS. 2A and 2B show a preferred embodiment in accordance with the present invention.

FIG. 3 shows an example of the present invention.

FIG. 4 shows another example of the present invention.

FIG. 5 is a block diagram of a mobile device of the present invention.

FIG. 6 is a flowchart depicting the preferred method of the present invention.

FIG. 7 is a block diagram of a mobile device of the present invention.

FIG. 8 is a flowchart depicting the preferred method of the present invention.

FIG. 9 is a block of diagram of a mobile device of the present invention.

FIGS. 10A and 10B shows examples of the present invention.

FIG. 11 is a flowchart depicting the preferred method of the present invention.

### DETAILED DESCRIPTION OF THE PREFERRED EMBODIMENTS

In the following descriptions, references are made to the accompanying drawings which form a part hereof, and which illustrate several embodiments of the present invention. It is understood that other embodiments may utilized and structural and operational changes may be made without from the scope of the present invention.

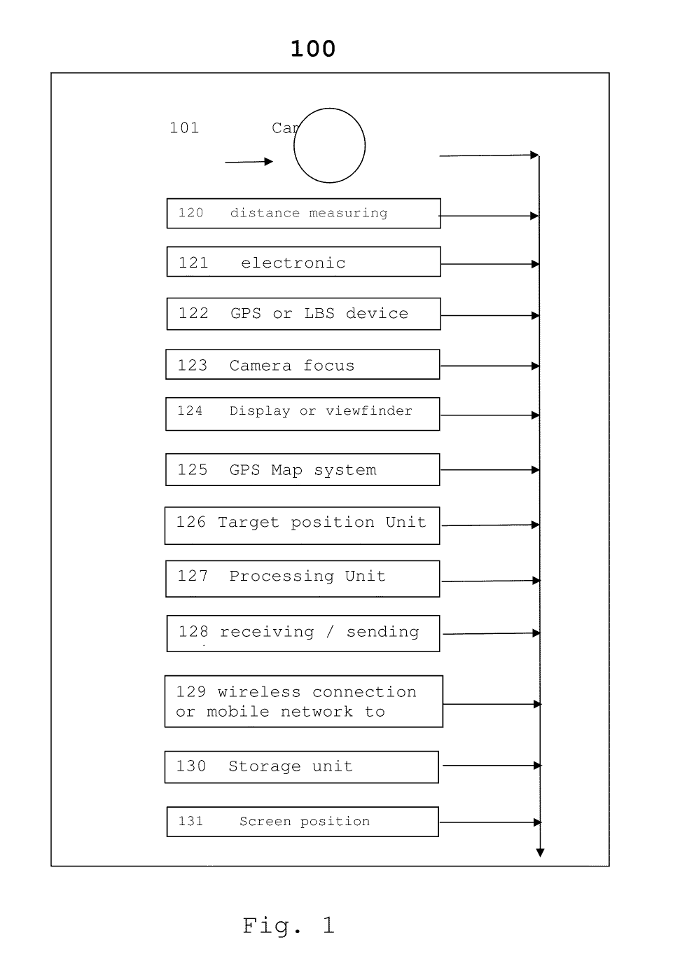

FIG. 1 shows an embodiment of the present invention. 100 is a mobile device, such as a cellar phone or iPad. The mobile device 100 includes a camera 101, which includes lenses, for allowing users to take pictures of one or more objects or targets, a camera focus device 123 for allowing users to focus on or select one or more objects or targets, a distance measuring unit 120 for measuring or detecting the distance between the mobile device (or the camera) and the focused or the selected objects or the targets, an electronic or digital compass 121 for indicating the direction of the lenses of camera, which is the direction of the focused or the selected objects or the targets, a GPS device or location based service device 122 for obtaining the global position of the mobile device, a viewfinder or display device 124 that captures images from the lens in said camera so the users are able to view the pictures they are taking, a GPS map system 125, a target position unit 126 for calculating the positions, preferably the global positions, of the focused or the selected objects or targets, a processing unit 127, a receiving and sending unit 128 for receiving or sending data through a wireless connection 129 to or from the Internet, and a storage unit 130. When a user tries to focus on or select an object or a target through the focus device 123, the distance measuring unit 120 measures the distance between the camera (or the mobile device) and the object or the target. The GPS device obtains the global position of the camera or the mobile device, and the compass 121 obtains the direction of the object or the target from the camera. Based on the global position of the camera, the distance between the camera and the target, and the direction of the target from the camera, the target position unit 126 calculates the global position of the object or the target. Then the processing unit 127 sends the target global position information to the stored local GPS map system or to a search engine through the sending and receiving unit 128 and the wireless connection or mobile network 129, and to query or retrieve the information about the focused or the selected object or the target, also to query or retrieve the information about the other interesting objects the targets that are near to or around the focused or the selected object or the target. The processing unit 127 receives the search results about the target from the search engine through the sending and receiving unit 128 and the wireless connection 129. The processing unit 127 processes the received results, and shows the information about the target in the viewfinder or the display device 124. The received results may also include the information about the other interesting objects or the targets, such the global positions and the short descriptions of the other interesting objects and the targets. The screen position calculator 131 calculates the relative positions, in the screen of the viewfinder or the display unit 124, of the other interesting objects or targets. The processing unit 127 processes can also show the information about the other interesting objects in the viewfinder or the display device 124. In this case, when a user is focusing or selecting an object or a target through the viewfinder or display device of a mobile device, the mobile system is able to show him the positions or the information on the viewfinder or the display screen of the mobile device about the other interesting objects or targets. The storage unit 130 stores the received global position of the mobile device, and the calculated global position of the focused target, and the pictures together. For example, when a user is focusing (pressing the focus button on the camera) on Eiffel Tower, based on the global position of the camera, the distance between the camera and Eiffel Tower, and the direction of the Eiffel Tower from the camera, the processing unit 126 calculates the global position of the Eiffel Tower, and sends the target global position to a search engine or local GPS map system to obtain the information about the target, Eiffel Tower. Then the processing unit 126 sends the obtained information to display 124, which will show something like “This is Eiffel Tower” for the target the users focused on. The search results from the search engine can also be a short version video to introduce the target. Although, in this example, it only mentions one focused target, there may be more than one target which are focused by users when they take pictures. In this case, system will calculates more than target global positions for the targets. In another example, the processing unit 126 sends the target global position together with the global position of the camera to a search engine or the local GPS map system to obtain the information about the target. In this case, the search engine or the local GPS system will know which side of the target the camera is focusing on, and the processing unit 126 will show something like “The target is the front side of Eiffel Tower” or “This is the west side of Eiffel”.

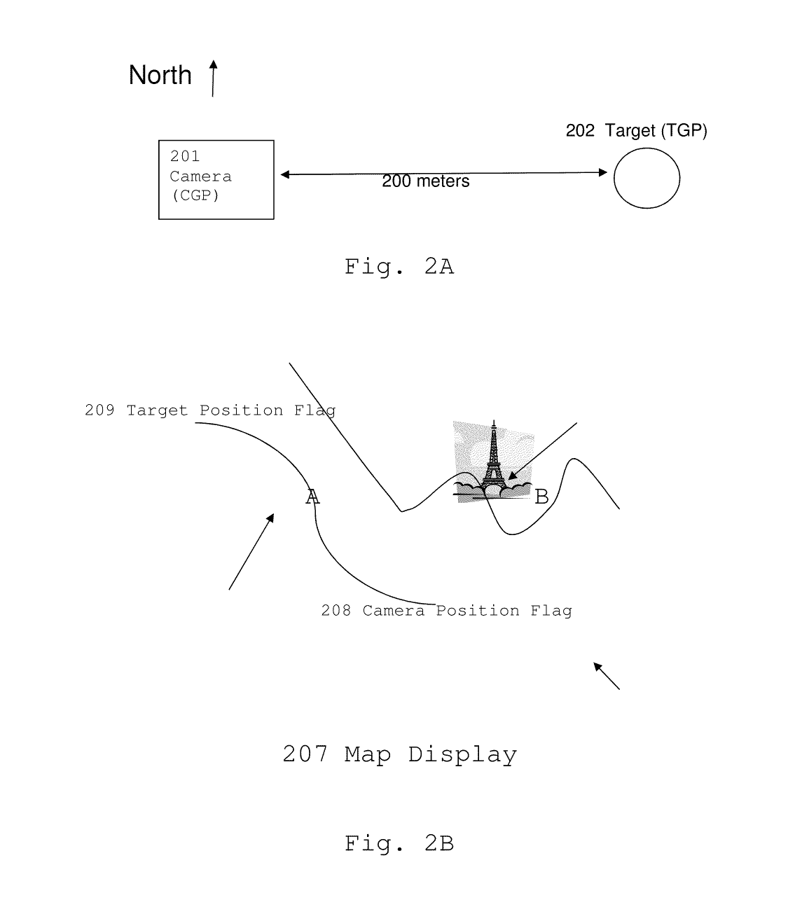

In FIG. 2A, 201 is the global position for a camera (CGP—camera's global position), and 202 is the global position of a target (TGP—target's global position), which a user is focusing on through the camera. The distance between the camera and the target is 200 meters, and the target is on the east side of the camera.

FIG. 2B shows a map with the indication or flag 208 for the position of the camera and the indication or flag 209 for the position of the target based the obtained or calculated global position of the target.

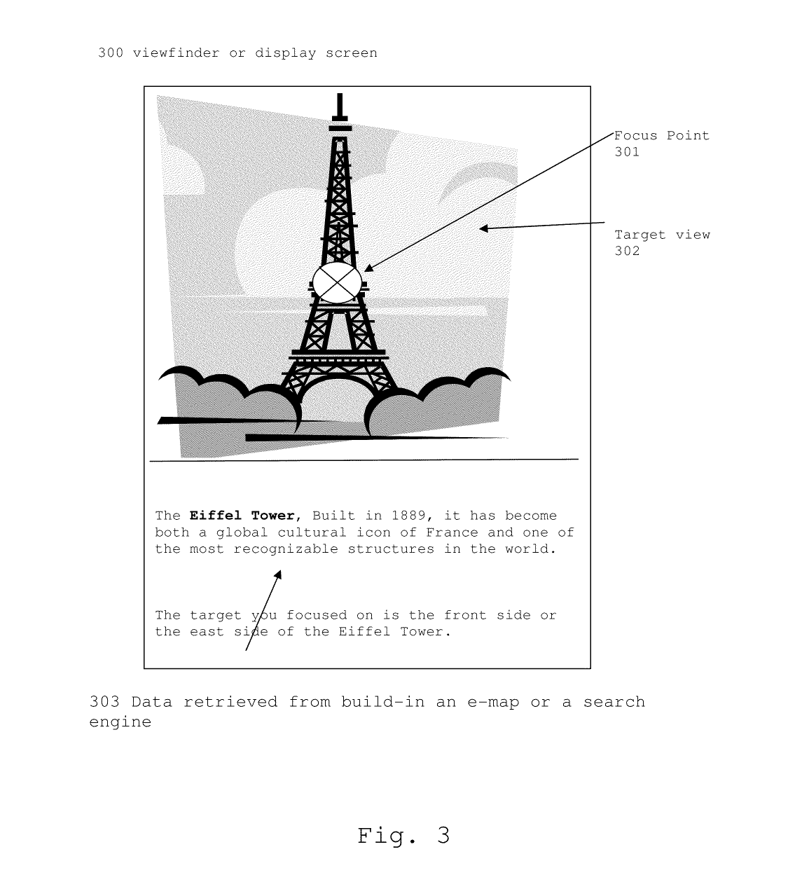

FIG. 3 shows an example that a search result is displayed in a viewfinder or a display device 300 in a mobile device. In the display screen, there are a target view 301, a focusing point 302, and a search or query result 303. From FIG. 3, it can be seen that the target is Eiffel Tower. The search or query result 303 shows “The Eiffel Tower, Built in 1889, it has become both a global cultural icon of France and one of the most recognizable structures in the world” and “The target you focused on is the front side or the east side of the Eiffel Tower”.

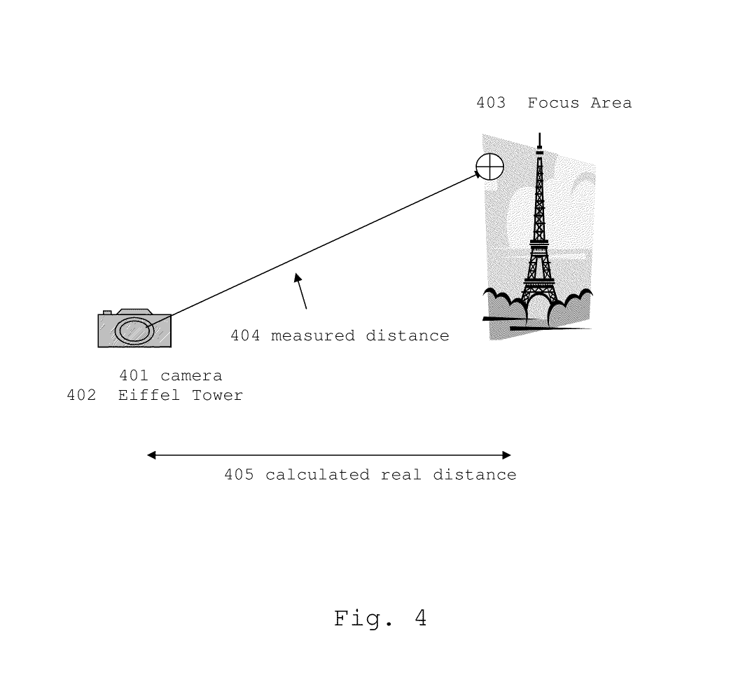

FIG. 4 shows another example of the present invention, wherein 401 is a camera of a mobile device that is held by a user, 402 is Eiffel Tower, 403 is the area focused or selected by the user, which is the top of Eiffel Tower. 404 is the distance between the camera and the focused area. 405 is the horizontal distance between the camera and the object. Since the camera lens is not exactly horizontal when users take pictures, the measured distance does not reflect the real distance between the object and the camera. However, it is possible to calculate the real distance between the object and the camera based on the distance between the focused or the selected area and the camera and the angle of the lens of the camera.

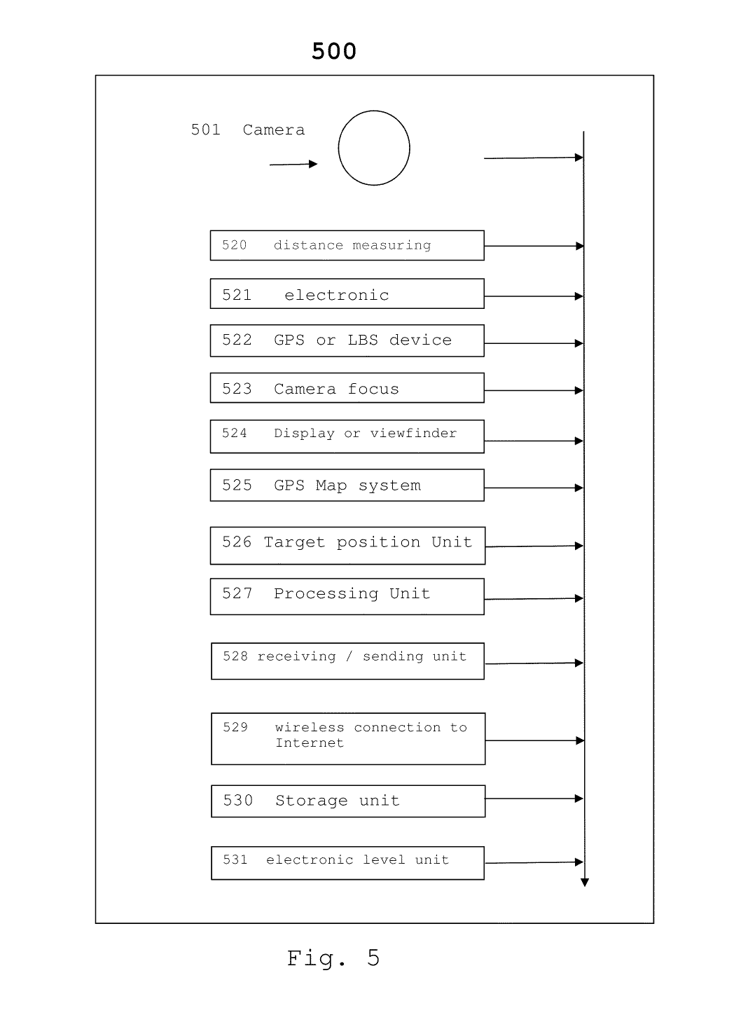

FIG. 5 shows another embodiment of the present invention. 500 is a mobile device, such as a cellar phone or iPad. The mobile device 500 includes a camera 501, which includes lenses, for allowing users to take pictures of one or more objects or targets, a camera focus device 523 for allowing users to focus on or select one or more objects or targets, a distance measuring unit 520 for measuring or detecting the distance between the mobile device (or the camera) and the focused (or the selected) objects or the targets, an electronic or digital compass 521 for obtaining the direction of the lenses of the camera, which is the direction of the focused or the selected objects or the targets, a GPS device or location based service device 522 for obtaining the global position of the mobile device, a viewfinder or display device 524 that captures images from the lens in said camera so the users are able to view the pictures they are taking, a GPS map system 525, an electronic or digital level 531 for measuring the horizontal level scale or angle of the lenses, a target position unit 526 for calculating the positions, preferably the global positions, of the focused or the selected objects or targets, a processing unit 527, a receiving and sending unit 528 for receiving or sending data through a wireless connection 529 to or from the Internet, and a storage unit 530. When a user tries to focus on or select an object or a target through the focus device 523, the distance measuring unit 520 measures the distance between the camera (or the mobile device) and the object or the target. The GPS device obtains the global position of the camera or the mobile device, and the compass 521 obtains the direction of the object or the target from the camera. Based on the global position of the camera, the distance between the camera and the target, the direction of the lenses and the horizontal level or angle of the lenses, the target position unit 526 calculates the global position of the object or the target. Then the processing unit 527 sends the target global position information to the stored local GPS map system or to a search engine through the sending and receiving unit 528 and the wireless connection or mobile network 529, and to query or retrieve the information about the focused object, also to query or retrieve the information about the other interesting objects the targets that are near to or around the focused or the selected object or the target. The processing unit 527 receives the search results about the target from the search engine through the sending and receiving unit 528 and the wireless connection 529. The processing unit 527 processes the received results, and shows the information about the target in the viewfinder or the display device 524. The received results may also include the information about other interesting objects or the targets, such the global positions and short descriptions of the other interesting objects and the targets. The screen position calculator 531 calculates the relative positions, in the screen of the viewfinder or the display unit 524, of the other interesting objects or targets. The processing unit 527 processes can also show the information about the other interesting objects in the viewfinder or the display device 524. In this case, when a user is focusing or selecting an object or a target through the viewfinder or display device of a mobile device, the mobile system is able to show him the positions or the information on the viewfinder or the display screen of the mobile device about the other interesting objects or targets. The storage unit 530 stores the received global position of the mobile device, and the calculated global position of the focused target, and the pictures together. For example, when a user is focusing (pressing the focus button on the camera) on Eiffel Tower, based on the global position of the camera, the distance between the camera and Eiffel Tower, and the direction of the Eiffel Tower from the camera, the processing unit 526 calculates the global position of the Eiffel Tower, and sends the target global position to a search engine or local GPS map system to obtain the information about the target, Eiffel Tower. Then the processing unit 526 sends the obtained information to display 524, which will show something like “This is the Eiffel Tower” for the target the users focused on. The search results from the search engine can also be a short version video to introduce the target. Although, in this example, it only mentions one focused target, there may be more than one target which are focused by users when they take pictures. In this case, the system will calculate more than target global positions for the targets. In another example, the processing unit 526 sends the target global position together with the global position of the camera to a search engine or the local GPS map system to obtain the information about the target. In this case, the search engine or the local GPS system will know which side of the target the camera is focusing on, and the processing unit 526 will show something like “The target is the front side of Eiffel Tower” or “This is the west side of Eiffel”. In this example, the target is Eiffel Tower. It could be something else, such as a restaurant, a park, or even a person who has signed in a LBS system, such as foursquare.com. In this case, the search engine returns the found person's contacts information, such as his or her Facebook or Twitter, or his or her chat room, like WHATSAPP, user id so that the users are able to join him or her as a friend, or follow him or her, or start to chat with him or her, by just clicking or touching on the focused target in the viewfinder or the display device 524, or by selecting email or chat or phone from a system prompted selecting list, or even by speaking to the device, which has a speech-to-command software installed. In this case, when the users click or touch on the interested object in the viewfinder or the display device 524, or speak out something like “I want to chat with her”, the processing unit 526 finds the chat id of the object and starts to call a Chat Apps with the chat id of the object so that the users can chat with the person when they focus on him or her in the viewfinder or the display device 524. In another case, when users touch or focus on an object in the viewfinder or the display in a mobile device, the process unit starts to send the target GPS information of the object to a search engine, and to get the information about the object. The information includes WEB address, email address, FACEBOOK id, TWITTER id, phone number, and other personal information, such as age, name, profession, interest, hobby, and the like. Then, the processing unit starts to call the corresponding Apps, such as GMAIL, WHATSAPPS or SYKPE, to communicate with the object. In the above example, the processing unit 527 sends the information, which includes the target global position and the device global position or the direction of the device or the target, to the stored local GPS map system or to a search engine through the sending and receiving unit 528 and the wireless connection or mobile network 529, and to query or retrieve the information about the focused object and its side (like east, south, west or north), also to query or retrieve the information about the other interesting objects the targets that are near to or around the focused or the selected object or the target.

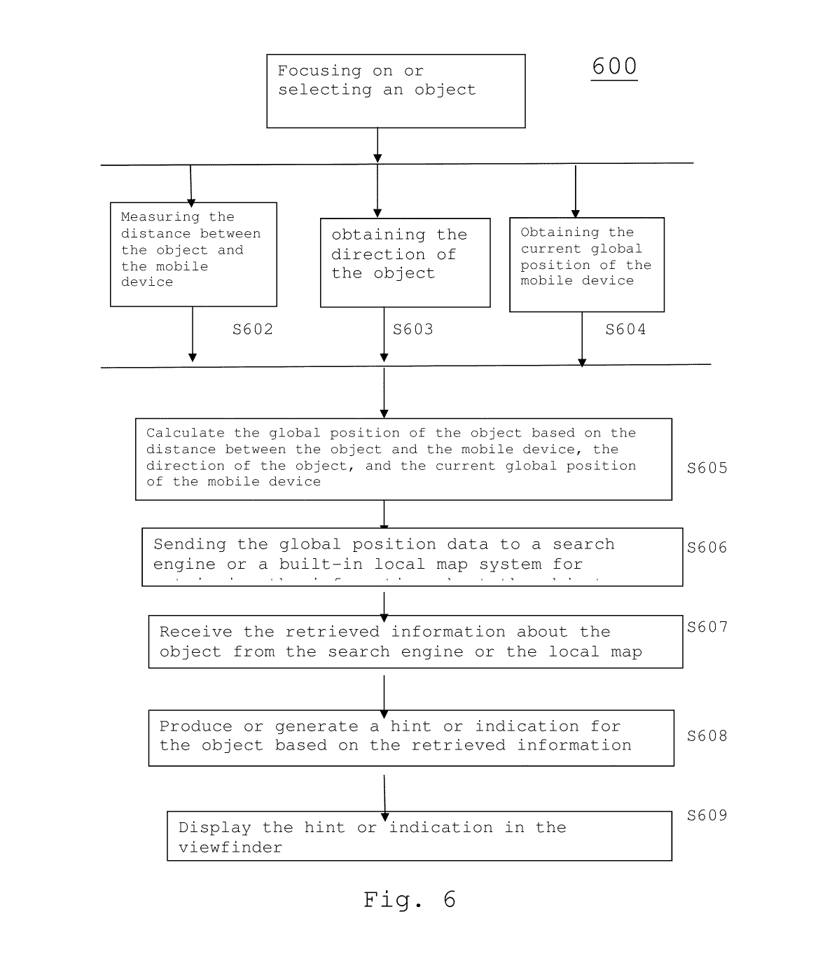

FIG. 6 displays a flowchart illustrating preferred method 600 for displaying the information about the object a user is focusing on through a mobile camera. In FIG. 6, the method 600 starts by a user focusing or selecting an object in step S601. In steps S602, S603 and S604, the distance measuring unit 120 measures the distance between the object and the mobile device, the electronic compass detects or obtains the direction of the lens of the camera 101, and the GPS or LBS device 122 obtains the global position of the mobile device. The parallel processing steps S602, S603 and S604 may be done simultaneously or in any order. In step S605, the target position unit 126 calculates the global position of the object based on the distance between the object and the mobile device, the direction of the object, and the current global position of the mobile device. In step S606, the receiving and sending unit 128 sends the global position of the object to a search engine or the local GPS map system 125 to retrieving or querying the information about the object. In step S607, the receiving and sending unit 128 receives the retrieved results from the search engine or the local GPS map system 125. In step S608, the processing unit 127 produces or generates a hint or indication for the object based on the retrieving or querying results. In step S609, the processing unit 126 displays the hint or indication in the display or viewfinder 124.

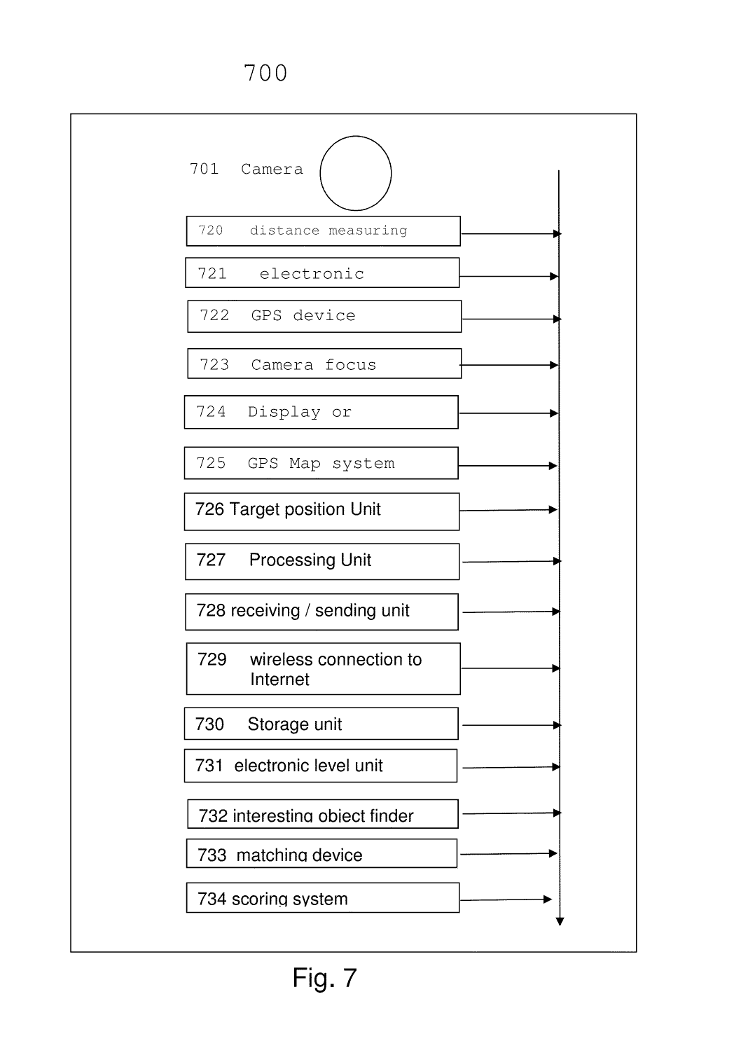

FIG. 7 shows another embodiment of the present invention. 700 is a mobile device, such as a cellular phone or iPad. The mobile device 700 includes a camera 701, which includes lenses, for allowing users to take pictures of one or more objects or targets, a camera focus device 723 for allowing users to focus on or select one or more objects or targets, a distance measuring unit 720 for measuring or detecting the distance between the mobile device (or the camera) and the focused (or the selected) objects or the targets, an electronic or digital compass 721 for obtaining the direction of the lenses of the camera, which is the direction of the focused or the selected objects or the targets, a GPS device or location based service (LBS) device 722 for obtaining the global position of the mobile device, a viewfinder or display device 724 that captures images from the lens in said camera so the users are able to view the pictures they are taking, a GPS map system 725, an electronic or digital level 731 for measuring the horizontal level scale or angle of the lenses, a target position unit 726 for calculating the positions, preferably the global positions, of the focused or the selected objects or targets, a processing unit 727, a receiving and sending unit 728 for receiving or sending data through a wireless connection 729 to or from the Internet, and a storage unit 730, an interested objects finder 732 for obtaining the interested objects nearby or around, a matching device 733 for checking whether the user's focused objects matches the interested objects, and a scoring system 734 for scoring based on the number of the match found in the matching device 733. The storage unit 730 stores the images together with the information about their obtained global positions of the devices and the calculated positions of the focused objects. In this case, search engines are able search images not only by their positions, but also by their face or side. For example, search engines return the information about east side of an object.

The GPS or LBS device 722 obtains the global location of the mobile device 700, and the interesting objects finder 732 sends the global position data of mobile device to the local GPS map system 725 or a search engine through the receiving and sending unit 728 for retrieving or querying the interesting objects or targets nearby or around. The interesting object finder 732 receives the retrieving or querying results, which include global position data, names, or the short descriptions about the interested objects, and processing unit 727 displays the interested objects in the viewfinder or display device 724. When the user focuses on or selects an object or a target through the focus device 723, the distance measuring unit 720 measures the distance between the camera (or the mobile device) and the object or the target, the electronic or digital level 731 for measuring the horizontal level scale or angle of the lenses of the camera, the GPS device obtains the global position of the camera or the mobile device, and the compass 721 obtains the direction of the object or the target from the camera. Based on the global position of the camera, the distance between the camera and the target, the direction of the lenses and the horizontal level or angle of the lenses, the target position unit 726 calculates the global position of the object or the target. Then the processing unit 727 sends the target global position information to the matching device 733 to check whether the focused object matches the interesting objects. When a match is found in the match device, processing unit 727 displays a signal or an indication in display or viewfinder 724, and the scoring system gives the user a reward score. For example, a user is at the front gate of Eiffel, and interesting object finder 732 finds an interesting object nearby or around the user and displays “Eiffel Tower is in front of you”. The user is focusing (pressing the focus button on the camera) on Eiffel Tower, based on the global position of the camera, the distance between the camera and Eiffel Tower, and the direction of the Eiffel Tower from the camera, the processing unit 726 calculates the global position of the Eiffel Tower, and sends the target global position to the matching device 733. The matching device 733, based on the obtained global position of the interesting objects and global position of the focused object, determines whether the focused object matches the interesting object. Since both the focused object and the interesting object is Eiffel Tower, the matching device 733 displays “Congratulations! You found the Eiffel Tower”, and the scoring system rewards the user a score for the success match. The interesting objects finder 732 can also obtain the interesting objects from a social network, like Facebook, or from a real time instant message, email, or chat room.

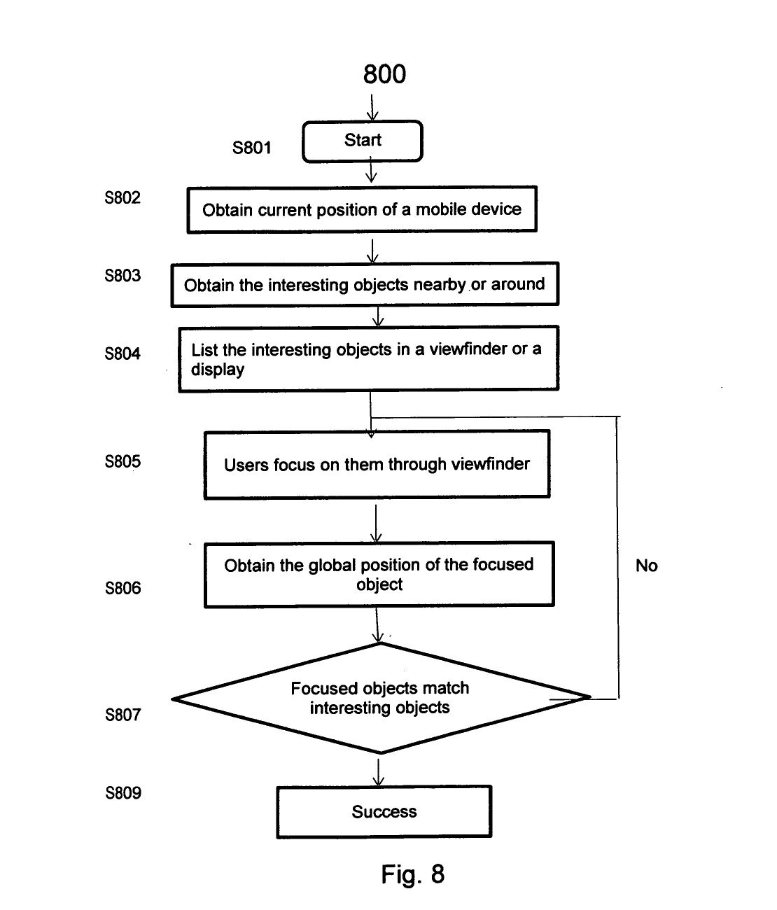

FIG. 8 displays a flowchart illustrating preferred method 800. In FIG. 8, method 800 starts in step S801. In step S802, GPS device 722 obtains the global position of the mobile device 700. In step S803, and the interesting objects finder 732 sends the global position data of mobile device to the local GPS map system 725 or a search engine through the receiving and sending unit 728 for retrieving or querying the interesting objects or targets nearby or around. In step S804, the processing unit 727 displays the interested objects in the viewfinder or display device 724. In step S805, users focus an object through the focusing device 723. In step S806, the distance measuring unit 720 measures the distance between the camera (or the mobile device) and the object or the target, the compass 721 obtains the direction of the focused object, the electronic or digital level 731 for measuring the horizontal level scale or angle of the lenses of the camera, and the target position unit 726 calculates the global position of the focused object based on the global position of the camera/mobile device, the distance between the camera and the target, the direction of the lenses and the horizontal level or angle of the lenses. In step S807, the matching device 733 compares the obtained global position of the interesting objects and global position of the focused object, and determines whether the focused object matches one of the interesting objects. If a match is found, it will go to step S809, success, otherwise, it will go back to step S805, to allow users to focus another object.

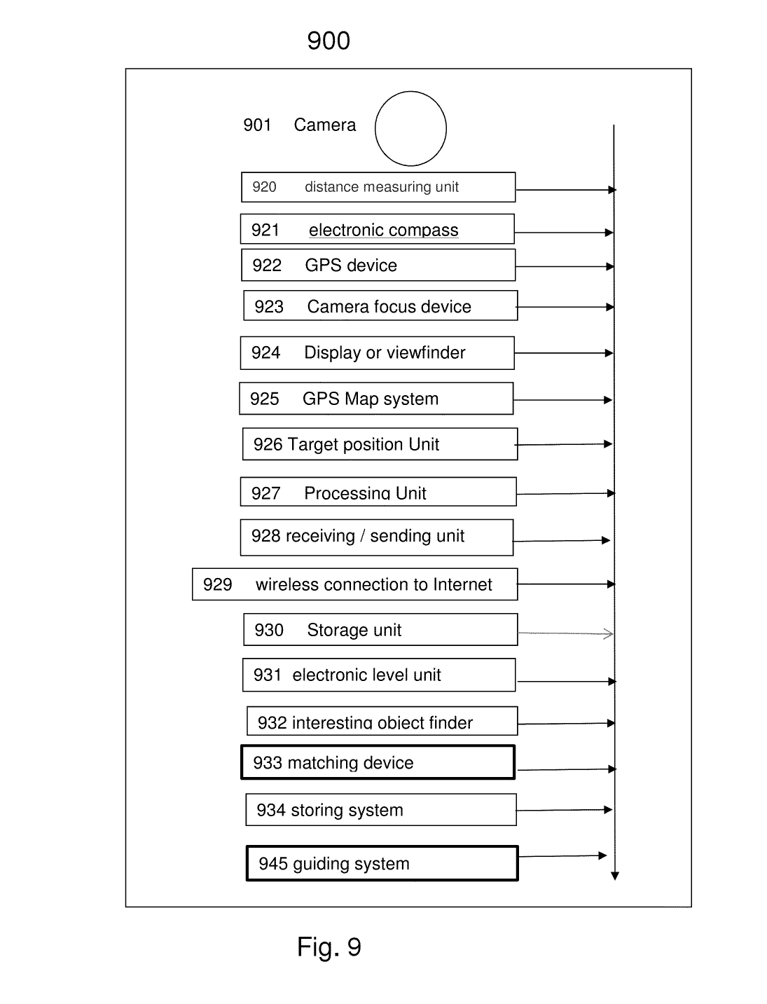

FIG. 9 shows another embodiment of the present invention. 900 is a mobile device, such as a cellar phone or iPad. The mobile device 000 includes a camera 901, which includes lenses to allow users to take pictures of one or more objects or targets, a camera focus device 923 for allowing users to focus on or select one or more objects or targets, a distance measuring unit 920 for measuring or detecting the distance between the mobile device (or the camera) and the focused (or the selected) objects or the targets, an electronic or digital compass 921 for obtaining the direction of the lenses of the camera, which is the direction of the focused or the selected objects or the targets, a GPS device or location based service (LBS) device 922 for obtaining the global position of the mobile device, a viewfinder or display device 924 that captures images from the lens in said camera so the users are able to view the pictures they are taking, a GPS map system 925, an electronic or digital level 931 for measuring the horizontal level scale or angle of the lenses, a target position unit 926 for calculating the positions, preferably the global positions, of the focused or the selected objects or targets, a processing unit 927, a receiving and sending unit 928 for receiving or sending data through a wireless connection 929 to or from the Internet, and a storage unit 930, an interested objects finder 932 for obtaining the interested objects nearby or around, a matching device 933 for checking whether the user's focused objects matches the interested objects, and a scoring system 934 for scoring based on the number of the match found in the matching device 933.

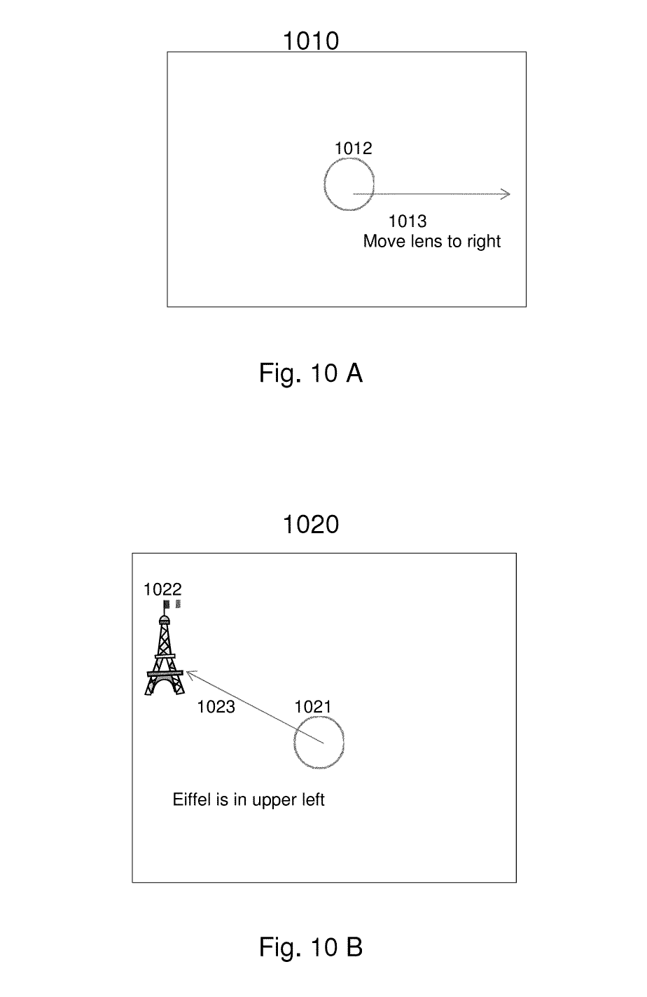

The GPS or LBS device 922 obtains the global location of the mobile device 900, and the interesting objects finder 932 sends the global position data of mobile device to the local GPS map system 925 or a search engine through the receiving and sending unit 928 for retrieving or querying the interesting objects or targets nearby or around. The interesting object finder 932 receives the retrieving or querying results, which include global position data, names, or the short descriptions about the interested objects, and processing unit 927 displays the interested objects in the viewfinder or display device 924. When the user focus on or select an object or a target through the focus device 923, the distance measuring unit 920 measures the distance between the camera (or the mobile device) and the object or the target, the electronic or digital level 931 for measuring the horizontal level scale or angle of the lenses of the camera, the GPS device obtains the global position of the camera or the mobile device, and the compass 921 obtains the direction of the object or the target from the camera. Based on the global position of the camera, the distance between the camera and the target, the direction of the lenses and the horizontal level or angle of the lenses, the target position unit 926 calculates the global position of the object or the target. Then the processing unit 927 sends the target global position information to the matching device 933 to check whether the focused object matches the interesting objects. When a match found in the match device, processing unit 927 displays a signal or an indication in display or viewfinder 924, and the scoring system gives the user a reward score. For example, a user is at the front gate of Eiffel, and interesting object finder 932 finds an interesting object nearby or around the user and displays “Eiffel Tower is in front of you”. The user is focusing (pressing the focus button on the camera) on Eiffel Tower, based on the global position of the camera, the distance between the camera and Eiffel Tower, and the direction of the Eiffel Tower from the camera, the processing unit 926 calculates the global position of the Eiffel Tower, and sends the target global position to the matching device 933. The matching device 933, based on the obtained global position of the interesting objects and global position of the focused object, determines whether the focused object matches the interesting object. Since both the focused object and the interesting object is the Eiffel Tower, the matching device 933 displays “Congratulations! You found the Eiffel Tower”, and the scoring system rewards the user a score for the success match. The interesting objects finder 932 can also obtain the interesting objects from a social network, like Facebook, or from a real time instant message, email, or chat room. Also, in FIG. 9, the mobile device, according to the present invention, further includes a guiding system 945 which guides and helps users to find the interested objects from the viewfinder or the display device. FIG. 10A shows an example of how the guiding system 945 works. 1010 is a viewfinder screen. 1012 is a focus area in the viewfinder screen 1012. In this case, based on the calculated the current global position of the focused object, the current global position of the interested object, and other current optical data of the camera, the guiding system 945 determines whether the interested object is in the viewfinder.

In FIG. 10, 1021 is a focus area in a viewfinder 1020. The guiding system 945 determines the interesting object is in the viewfinder based on the calculated current global position of the focused object, the current global position of the interested object, and other optical information of the camera. The guiding system 945 performs image processing, and obtains the position of the interested object in the viewfinder 1020. Then, the guiding system 945 displays an indicator 1023 to show users where the interested object is in the viewfinder 1020.

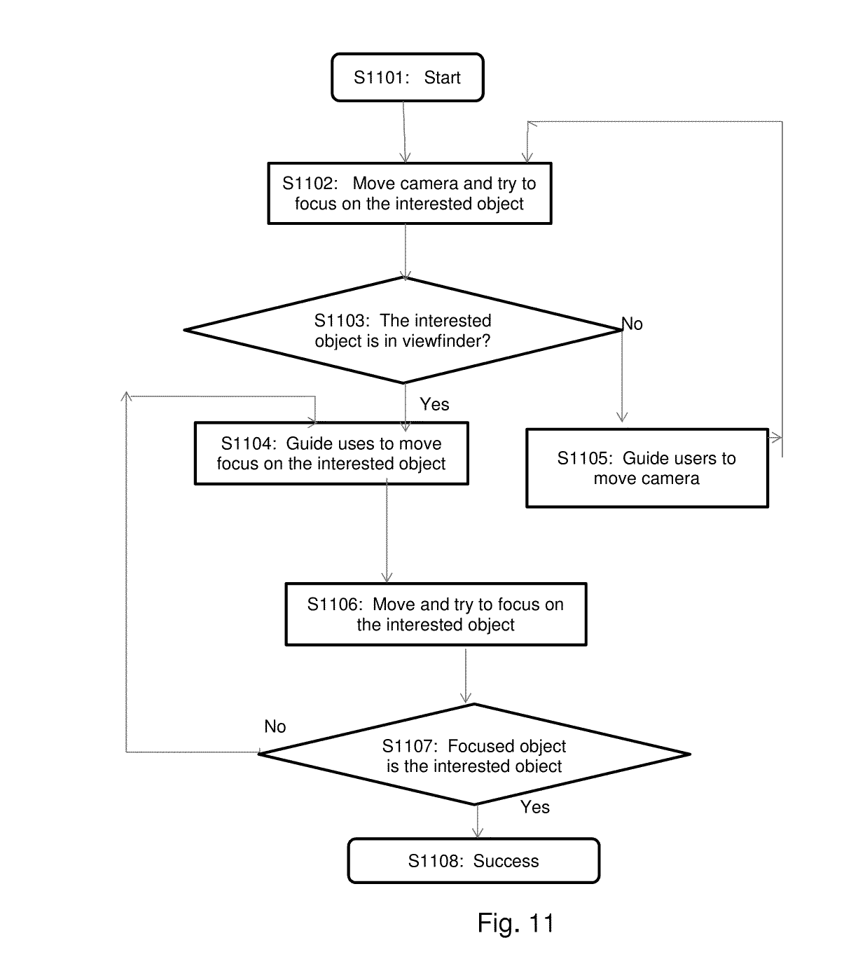

FIG. 11 displays a flowchart illustrating preferred guiding method. In step S1101, the guiding system 945 starts its operation. In step S1102, a user moves his camera around and tries to focus on an object in the viewfinder 924. In step S1103, the guiding system 945 determines whether his interested object is in the viewfinder 924 based on the current global position of the camera, the direction of the lenses of the camera, and other optical information of the camera. If yes, it will go to the next step S1104, and else it will go to step S1105. In step S1105, the guiding system 945 guides the user on moving the camera. For example, it will show “Move your camera to left for viewing Eiffel Tower”. In step S1104, the guiding system 945 guides the user on focusing on the object within the viewfinder 924. For example, it shows an arrow to Eiffel Tower in the viewfinder, and a message “Move your focus area to the left”. In step S1106, the user moves the focus area in the viewfinder 945 to the left based on the instructions given by the guiding system 945. In step S1107, the matching device 933 determines whether the current focused object matches the interested object based on the current global position of the focused object and the global position of the interested object. If a match found, it goes to step S1108, success, else it goes back to step S1104.

In the present invention, the mobile device/processing unit sends the matching or focus information to a server, which collects these kinds of matching or focusing information from many mobile cameras, counts these matched or focused numbers, and ranks the objects by the number of the focus or match. Therefore, based on the numbers of the objects have been focused or have been taken into pictures, the server is able to tell, at the period of time, within a geographic range, which object is the most attractive object, or is able to show a list of objects ordered by the grade of attractiveness. The matching device 933 obtains the rank or the grade of attractiveness of the object from the server, and shows the rank or the grade of the attractiveness of the focused object in the display or viewfinder.

In another case, the mobile device includes a display unit for displaying the attractiveness ranks of the objects in the viewfinder or display, or for displaying indicators of those attractive objects in the viewfinder or display.

In the above, the guiding system 945 further includes an image processing unit, which compares the characteristics of the interested objects and the characteristics of the current image in the viewfinder.

Therefore, the forgoing is considered as illustrative only of the principles of the invention. Furthermore, since numerous modifications and changes will readily occur to those skilled in the art, it is not desired to limit the invention to the exact construction and operation shown and described. Accordingly, all suitable modifications and equivalents may be resorted to, falling within the scope of the invention.

1. A mobile device having a camera system comprising:
a viewfinder or display unit that captures an image from a lens in said camera;
means for allowing users to select or focus an object in said captured image;
means for obtaining the global position or location of the mobile device;
a compass unit for obtaining the direction of said selected or focused object;
means for measuring the distance between the mobile device and the object;
means for calculating the current position of the object based on the position of the mobile device, the direction of the object and the distance between the mobile device and the object;
means for submitting the current position of the object to a search engine or a local map database for retrieving or querying the information about the object;
means for receiving results of the retrieve or the query from the search engine or the local map database;
means for producing and displaying a hint or an indication for the object based on the retrieving results.

2. A mobile device according to claim 1 further comprising:
means for measuring or obtaining the horizontal level scale or angle of the lenses;
means for means for calculating the current position of the object based on the position of the mobile device, the direction of the object, the horizontal level scale or angle of the lenses, and the distance between the mobile device and the object.

3. A mobile device according to claim 2 further comprising:
means for storing said image together with the obtained global position and the calculated position of the focused objet.

4. A mobile device according to claim 3 further comprising:
means for obtaining one or many interesting objects nearby.

5. A mobile device according to claim 4 further comprising:
means for checking the match between one of the interesting objects and the focused objects, and showing matching results;
means for displaying or indicating the match successful.

6. A mobile device according to claim 5 further comprising:
means for automatically guiding and helping users to find the interested objects from the viewfinder or the display device;
means for graphically showing users hints or directions to find the interested objects.

7. A mobile device according to claim 6 further comprising:
means for sending said match checking results to a search engine, which collects many match data from many mobile devices, and shows the ranks or the grades of the attractiveness of the focused objects.

8. A mobile device according to claim 7 wherein said attractiveness ranks or grades are based on the numbers of the focus of the objects, and the mobile device further includes means for displaying the attractiveness ranks or grades of the objects in the viewfinder or the display.

9. A mobile device according to claim 8, wherein said checking match means determines, based on the obtained global position of the interesting objects and global position of the focused object, whether the focused object matches the interesting object.

10. A mobile device according to claim 9, wherein said search results include one or many social IDs, email addresses, chat user IDs or phone numbers of the objects, said mobile device further comprises:
means for, in response the user's a trig action, to call a corresponding Apps, which have been installed in the mobile device, to communicate with the focused object.

11. A mobile device according to claim 10 further comprising:
means for displaying the rank of attractiveness of objects nearby in a certain period of time.

12. A mobile device according to claim 11 further comprising:
means for submitting the current position of the object and the current position of the mobile device to a search engine or a local map database for retrieving or querying the information about the object and the object face or side which face to the user or the lens.

13. A method for a mobile device, which includes a built-in a digital camera, a GPS or LBS device, a digital compass, and a distance measuring unit, comprising the steps of:
selecting or focusing an object in an image associated with a viewfinder or a display unit of the digital camera;
obtaining the current position of the mobile device from the GPS device;
obtaining the direction of the object from a digital compass;
measuring the distance between the mobile device and the object from a distance measurement device;
calculating the current position of the object based on the position of the mobile device, the direction of the object and the distance between the mobile device and the object;
sending the current position of the object to a search engine or a built-in local map system for retrieving the information about the object;
producing a hint or an indication of the object based on the retrieved information;
displaying the hint or the indication of the object in the viewfinder or the display unit.

14. A method for a mobile device of claim 13 further comprising the steps:
obtaining the attractiveness ranks or grades of the objects in the viewfinder or the display unit;
displaying the attractiveness ranks or grades of the objects in the viewfinder or the display unit.

15. A method for a mobile device of claim 13 further comprising:
obtaining global positions of the interested objects nearby from a search engine or a build-in local map system;
comparing the global position of the focused object and the global positions of the interested objects;
displaying or showing a match indictor if the global position of the focused object is the same as the global position of one the interested object.

16. A method for a mobile device of claim 15 further comprising:
scoring or grading based on the number of the matches found.
